(19) United States
(12) Patent Application Publication
(10) Pub. No.: US 2019/0059501 A1
(43) Pub. Date: Feb. 28, 2019

(54) Method of manufacturing a protective helmet and protective helmet manufactured in accordance with said method

(71) Applicant: ABUS August Bremicker Söhne KG, Wetter-Volmarstein (DE)

(72) Inventor: Marc Von Dunten, Essen (DE)

(21) Appl. No.: 16/111,340

(22) Filed: Aug. 24, 2018

(30) Foreign Application Priority Data
Aug. 25, 2017 (DE) 102017119535.1

(51) Int. Cl. A42C 2/00; A42B 3/06; B29C 45/00; B29C 45/14; B29C 39/10; B29C 39/00

(52) U.S. Cl. CPC A42C 2/002; A42B 3/06; B29C 45/0001; B29L 2031/4821; B29C 45/14336; B29C 39/10; B29C 39/003; B29C 45/14795

(57) ABSTRACT

A method of manufacturing a protective helmet, in particular a bicycle helmet, that has a shock-absorbing helmet body having a concave inner side and a convex outer side and that has an outer shell arranged at the outer side of the helmet body. The method includes the steps: placing the outer shell into a mold; and filling a casting material into the mold at at least one filling point to form the helmet body. The casting material connects to an inner side of the outer shell. The filling point for the casting material is provided at the outer side of the formed helmet body, with the outer shell having an opening in the region of the filling point.

### CROSS-REFERENCE TO RELATED APPLICATIONS

This application claims priority to German Patent Application No. DE 102017119535.1 filed on Aug. 25, 2017, the entire contents of which are incorporated herein by reference.

### TECHNICAL FIELD

The present disclosure relates to a method of manufacturing a protective helmet, in particular a bicycle helmet, that has a shock-absorbing helmet body having a concave inner side and a convex outer side and that has an outer shell arranged at the outer side of the helmet body, comprising the steps: placing the outer shell into a mold and filling a casting material into the mold at at least one filling point to form the helmet body, wherein the casting material connects to an inner side of the outer shell. The present disclosure further relates to a protective helmet manufactured in accordance with the method.

### BACKGROUND

Protective helmets, in particular a bicycle helmets, serve for the protection of the user from head injuries in the case of a fall or of an impact of an object on the head of the user. For this purpose, the protective helmet comprises a helmet body that has a generally concavely shaped inner side that faces the head of the user and a generally convexly shaped outer side that is remote from the head of the user. The protective helmet, in particular on a use as a bicycle helmet, may in particular have a plurality of ventilation openings that extend through the outer shell and through the helmet body. The helmet body should absorb the kinetic energy acting on the protective helmet on an impact (crash or impact) as much as possible by inelastic and/or elastic deformation. A strap fixing system may additionally be fastened to the helmet body by means of which the helmet body may be fixed to the head of the user and which may, for example, comprise a plurality of neck straps and chin straps.

The protective helmet furthermore comprises an outer shell that is arranged at the outer side of the helmet body and that may have a generally concavely shaped inner side and a generally convexly shaped outer side corresponding to the helmet body. The outer shell may likewise exert a protective function (e.g. shock absorption or reduction of the coefficient of friction for a sliding along of the protective helmet at a rough surface) or it only satisfies a decorative function.

In a manufacturing method in accordance with the so-called in-mold technology, the outer shell is placed into a mold. A casting material is then filled into the mold at at least one filling point to form the helmet body, with the casting material connecting to the inner side of the outer shell. A permanently force transmitting connection may be established between the helmet body and the outer shell with a few worksteps by this method. In this respect, a foaming of the casting material may be provided depending on the choice of the casting material. The method may in particular also be carried out as an injection molding process in which the casting material (as in injection molding material) is filled or injected into the mold at pressure.

In such a manufacturing method, there are, however, unwanted restrictions with regard to the possible shape of the helmet body. Complex shapes—for example branched ventilation structures or stabilization structures—may in particular not easily be produced since the casting material cannot spread as widely as desired within the mold before the solidifying.

### SUMMARY

It is an object to provide a method of manufacturing a protective helmet of the named kind that still further simplifies the manufacture of the protective helmet and in particular also enables the production of more complex shapes of the helmet body. A corresponding protective helmet should furthermore be provided.

This object is satisfied by a method of manufacturing a protective helmet having the features that the filling point for the casting material is provided at the outer side of the formed helmet body, with the outer shell having an opening in the region of the filling point.

In the method in accordance with the present disclosure, the casting material is filled into the mold in accordance with the in-mold technology while the outer shell of the protective helmet to be formed has already been placed into the mold. The filling of the casting material into the mold takes place at at least one filling point that is provided at the (convex) outer side of the helmet body to be formed. The mold comprises at least one corresponding filling passage for the casting material for this purpose. The filling point is that point of the outer side of the helmet body to be formed or of the formed helmet body at which the filling passage of the mold opens. To enable such a filling of the casting material at the outer side of the helmet body or at the corresponding (concave) inner surface of the mold, the outer shell (placed into the mold) has an opening (e.g. a cut-out or recess) in the region of the filling point, that is an interruption such that the filling point of the helmet body is exposed at the outer side of the formed helmet body directly after the casting process and after the removal of the helmet body and of the outer shell from the mold.

At least one filling point for the casting material is thus also provided, diverging from the typical procedure in the manufacture of protective helmets in accordance with the in-mold technology, at the outer side of helmet body. Such a filling point at the surface of the helmet body may result in a generally perceivable disruption of the appearance of the helmet body that may otherwise be produced homogeneously so that it is obvious to provide the filling point for the casting material at the (concave) inner side of the helmet body that faces the head of the user in use of the protective helmet and is thus not visible. However, in that, diverging from this typical procedure, at least one filling point is arranged at the outer side of the helmet body, the shape of the helmet body becomes more flexible since there are additional possibilities for the filling of the casting material into the mold at suitable positions. It is hereby possible also to produce complex helmet structures in accordance with the in-mold technology, for example having a plurality of ribs and passages at the inner side of the helmet body. When the filling point(s) for the casting material is/are provided at the outer side of the helmet body, the design of the mold may also be made simpler. A more flexible arrangement of the filling passages (also at the convex outer side of the helmet body) may in particular simplify the arrangement of the slides typically required in a mold.

In accordance with some embodiments, the filling point for the casting material may be arranged spaced apart from a marginal region (e.g. a peripheral edge) of the formed helmet body. A wide-area distribution of the casting material within the mold is hereby possible.

In accordance with some other embodiments, the casting material may be filled into the mold at a plurality of filling points, i.e. the mold may have a plurality of filling passages for the casting material. In this embodiment, at least one of the plurality of filling points (in particular also each of the plurality of filling points) may be provided at the outer side of the formed helmet body. A wide-area homogeneous distribution of the casting material within the mold may also hereby be achieved even with a complex shape.

In accordance with some embodiments, expanded polystyrene styrofoam (EPS) may be provided as the casting material.

In accordance with some other embodiments, the mold may be an injection mold, with the casting material being an injection molding material that is filled into the injection mold at pressure.

As regards the opening of the outer shell in the region of the filling point for the casting material, the opening may be closed peripherally, i.e. the outer shell peripherally surrounds the filling point of the helmet body. The outer shell may simultaneously surround a ventilation opening of the helmet body.

The outer shell of the protective helmet may be in one part or in multiple parts.

The outer shell of the protective helmet may, for example, have a shell, in particular a film, of polyvinyl chloride (PVC), polyethylene terephthalate (PET) or a polycarbonate (PC).

In accordance with some embodiments, the outer side of the helmet body may be covered by a cover part in the region of the filling point after the removal of the helmet body and of the outer shell connected thereto from the mold. The cover part may in particular be a shell part that at least substantially corresponds to the appearance of the outer shell of the protective helmet. The visually perceptible filling point of the helmet body at its outer side may hereby be laminated with a small material and labor effort. The corresponding shell part may correspond to the outer shell of the protective helmet with respect to material and/or color. The cover part, in particular the shell part, may, however, also be formed from a different material than the outer shell of the protective helmet, for example from acrylonitrile butadiene styrene copolymer (ABS), polyethylene (PE), polypropylene (PP), aramid (in particular Kevlar), glass fiber, or a combination thereof.

The cover part, in particular the shell part, may also additionally be provided with a damping material, in particular with a damping material layer, that is foamed on, for example, or attached in another manner. This may in particular be provided in an embodiment in which the cover part, in particular the shell part, has additional or different types of damping properties or forms aerodynamically optimized surfaces.

The cover part, in particular the shell part, may have a reception device—for example a fastening opening, a fastening recess, or an elevated fastening portion—for receiving a helmet accessory, e.g. a lighting device or a camera.

The fastening of the cover part to the helmet body and/or to the outer shell may take place, for example, by means of a latch connection or by adhesive bonding.

Alternatively to this, provision may, for example, be made that the protective helmet has a plurality of ventilation openings that extend through the outer shell and through the helmet body, with the filling point provided at the outer side of the helmet body being arranged at a boundary surface of one of the ventilation openings. In such an embodiment, the filling point for the casting material may be arranged set back relative to the generally convex surface of the helmet body so that the filling point is visually less obtrusive.

In accordance with some other embodiments, the protective helmet may have a recess for receiving a helmet accessory, e.g. a lighting device or a camera, with the filling point for the casting material provided at the outer side of the helmet body being arranged at a boundary surface of the recess. The filling point may hereby also be arranged set back relative to the generally convex surface of the helmet body or may even be covered by a helmet accessory placed into the recess so that the filling point is visually less perceived or is not perceived at all.

The object of the present disclosure is also satisfied by a protective helmet that has a shock-absorbing helmet body and an outer shell arranged at the outer side of the helmet body and that has in particular been manufactured in accordance with a method in accordance with any one of the above-described embodiments, with the helmet body having at its surface at least one filling point for the casting material forming the helmet body, with the filling point being arranged at the outer side of the helmet body, and with the outer shell having an opening in the region of the filling point.

With such a protective helmet, the outer side of the helmet body may be covered by a cover part of the explained kind, in particular by a shell part, in the region of the filling point.

The present disclosure will be described in the following only by way of example with reference to the drawings.

### BRIEF DESCRIPTION OF THE DRAWINGS

FIG. 1 shows a cross-sectional view of a bicycle helmet in a mold; and

FIG. 2 shows a side view of a bicycle helmet with a shell part to be fastened to the outer side.

### DETAILED DESCRIPTION

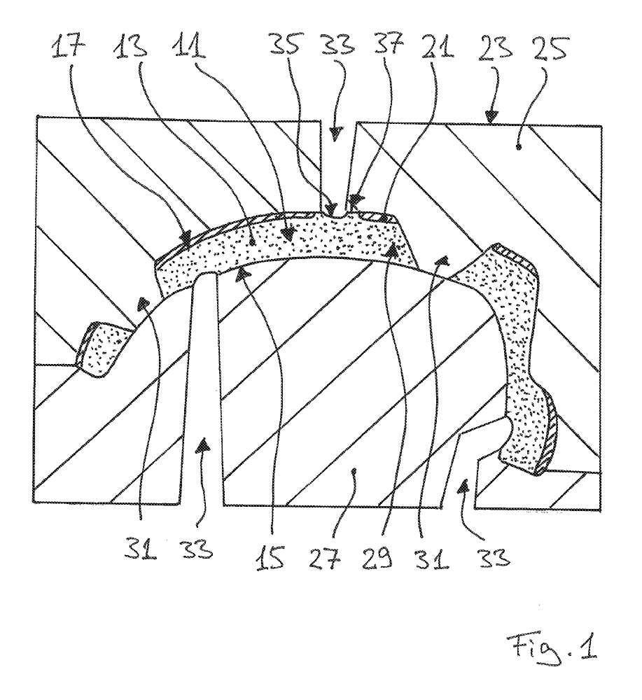

The bicycle helmet 11 shown in FIG. 1 comprises a helmet body 13, for example composed of EPS styrofoam, having a concave inner side 15 and a convex outer side 17 and comprises an outer shell 21, composed of a polycarbonate, for example, arranged at the outer side 17 of the helmet body 13. The bicycle helmet 11 is manufactured on the basis of an in-mold technique and is located in the state shown in FIG. 1 in a mold 23 that comprises a matrix 25 and a patrix 27 that bound a hollow space 29 of the mold 23. In the cross-sectional view shown in FIG. 1, the cross-sectional plane of the drawing extends through a plurality of ventilation openings 31 of the bicycle helmet 11 so that both the helmet body 13 and the outer shell 21 each appear segment-like. The helmet body 13 and the outer shell 21, however, actually form a respective contiguous structure.

For the manufacture of the bicycle helmet 11, the outer shell 21 is first placed into the matrix 25 so that a convex outer side of the outer shell 21 contacts a concave inner surface of the matrix 25. The mold 23 is then closed. A casting material is then filled into the mold 23 to form the helmet body 13. The mold 23 has three filling passages 33 for this purpose. The middle one of these three filling passage 33 is located in the matrix 25 and opens at a filling point 35 of the helmet body 13 that is arranged at the outer side 17 of the helmet body 13 to be formed, spaced apart from the margin of the helmet body 13. So that the casting material may pass through the middle filling passage 33 into the hollow space 29 of the mold 23, the outer shell 21 has an opening 37 in the region of the filling point 35, i.e. the helmet body 13 to be formed is not covered by the outer shell 21 at this point.

After the filling of the casting material into the mold 23, it connects with an inner side of the outer shell 21 in a force-transmitting manner. The mold 23 may be opened after a hardening period. The bicycle helmet 11 may then be removed from the mold 23 and may be provided with further equipment elements, for example with a cushioning at an inner side and with a strap fixing system.

Innovative possibilities result for the shape of the helmet body 13 in that the filling point 35 of the middle filling passage 33 is arranged at the outer side 17 of the helmet body 13 since a homogeneous distribution of the casting material within the hollow space 29 of the mold 23 may be effected more easily. The structure of the mold 23 may also hereby be made more simple.

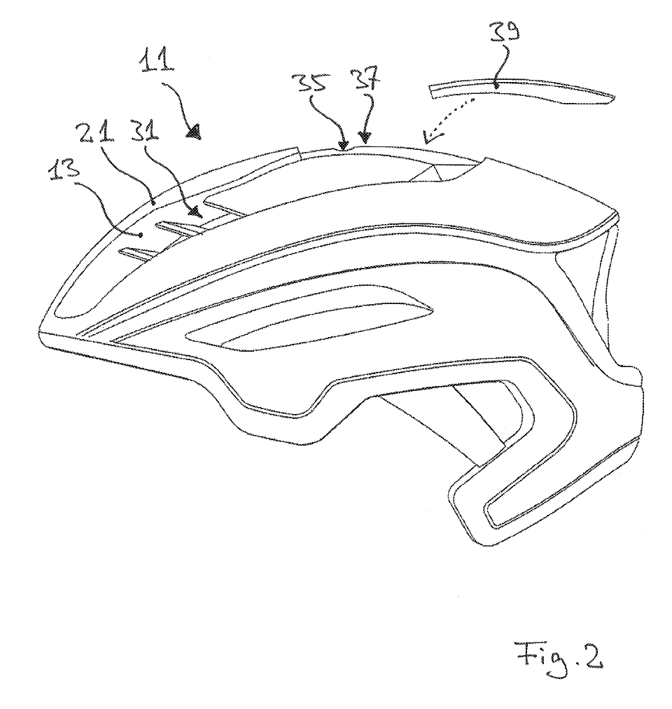

It may be seen from FIG. 2 that with such a bicycle helmet 11, a filling point 35 at the outer side 17 of the helmet body 13 may be covered by a shell part 39 (cf. the arrow shown dashed). The shell part 39 may correspond to the outer shell 21 with respect to material and/or color. As explained above, a different kind of cover part may also be provided instead of the shell part 39.

1. A method of manufacturing a protective helmet that has a shock-absorbing helmet body having a concave inner side and a convex outer side and that has an outer shell arranged at the outer side of the helmet body, the method comprising the steps:
placing the outer shell into a mold; and
filling a casting material into the mold at at least one filling point to form the helmet body, wherein the casting material connects to an inner side of the outer shell,
wherein the filling point is provided at the outer side of the formed helmet body, with the outer shell having an opening in a region of the filling point.

2. The method in accordance with claim 1, wherein the filling point is arranged spaced apart from a margin of the helmet body.

3. The method in accordance with claim 1, wherein the casting material is filled into the mold at a plurality of filling points, with at least one of the plurality of filling points being provided at the outer side of the formed helmet body.

4. The method in accordance with claim 1, wherein the opening of the outer shell is peripherally closed.

5. The method in accordance with claim 1, wherein the outer side of the helmet body is covered by a cover part in the region of the filling point after a removal of the helmet body and of the outer shell connected hereto from the mold.

6. A protective helmet that has a shock-absorbing helmet body and an outer shell arranged at the outer side of the helmet body and that has in particular been manufactured in accordance with a method in accordance claim 1,
wherein the helmet body has at least one filling point at its surface for the casting material forming the helmet body,
wherein the filling point is arranged at the outer side of the helmet body, with the outer shell having an opening in the region of the filling point.

7. The protective helmet in accordance with claim 6, wherein the outer side of the helmet body is covered by a cover part in the region of the filling point.
